(19) United States
(12) Patent Application Publication
(10) Pub. No.: US 2023/0409969 A1
(43) Pub. Date: Dec. 21, 2023

(54) Providing Fairness in Fine-Tuning of Pre-Trained Language Models

(71) Applicant: Oracle International Corporation, Redwood City, CA (US)

(72) Inventors: Swetasudha Panda, Burlington, MA (US); Ariel Kobren, Cambridge, MA (US); Michael Louis Wick, Lexington, MA (US); Qinlan Shen, Burlington, MA (US)

(21) Appl. No.: 18/176,374

(22) Filed: Feb. 28, 2023

Related U.S. Application Data
(60) Provisional application No. 63/366,461, filed on Jun. 15, 2022.

(51) Int. Cl. G06N 20/00

(52) U.S. Cl. CPC G06N 20/00

(57) ABSTRACT

Bias in a language model generated through fine tuning of a pre-trained language model may be mitigated, whether the bias may be incorporated in the pre-trained language model or in fine-tuning data. A pre-trained language model may be fine-tuned using downstream training data. Prior to tuning, elements within the downstream data may be identified that either match or serve as proxies for one or more identity elements associated with training bias sensitivity. Proxy elements may be identified using an analysis of distributions of the downstream elements and distributions of identity elements. Once the elements are identified, instances of the identified elements may be replaced in the downstream data with one or more masking element to generate masked downstream data. A fine-tuned language model with reduced bias may then be generated from the pre-trained language model by tuning the pre-trained language model using the masked downstream data.

### RELATED APPLICATIONS

This application claims benefit of priority to U.S. Provisional Application Ser. No. 63/366,461, entitled “Providing Fairness in Fine-Tuning of Pre-Trained Language Models,” filed Jun. 15, 2022, and which is incorporated herein by reference in its entirety.

### BACKGROUND

### Field of the Disclosure

This disclosure relates to detecting and mitigating bias and unfairness in item rankings.

### Description of the Related Art

Machine learning systems are increasingly employed to improve decision making in business applications, but when machine learning systems participate in decision making in certain domains, such as credit or employment, there is a need to ensure that the system free of bias, often according to rules and definitions set forth by regulatory bodies in those domains. In this context, bias often refers to some measure of discrepancy between the behavior of the machine learning system and mathematical rules established by these external regulatory bodies.

Machine learning models, however, are often developed using training data created with unintended biases. This manifests as bias in results when the models are applied. While future machine learning models may be developed that avoid these unintended biases, it is often the case that organizations responsible for ensuring fairness in results are separate from those that develop the machine learning models themselves. As a result, cooperation to implement necessary fairness constraints may be difficult or impossible. In such cases, ensuring fairness in results is an unresolved matter.

### BRIEF DESCRIPTION OF THE DRAWINGS

FIG. 1 is a block diagram of a machine learning system that provides fairness when fine-tuning pre-trained language models, according to some embodiments.

FIG. 2 is a block diagram of a bias masker of a machine learning system that masks identity elements and proxies for identity elements from a data set before training of a language model, according to some embodiments.

FIG. 3 is flow diagram illustrating a process for provides fairness when fine-tuning pre-trained language models, according to some embodiments.

FIG. 4 is flow diagram illustrating a process for masking proxies for identity elements from a training data set, according to some embodiments.

FIG. 5 is flow diagram illustrating a process for updating a language model according to an updated set of identity elements. according to some embodiments.

FIG. 6 illustrates an example computing system, in some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component may be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

Where any or all of the terms “comprise”, “comprises”, “comprised” or “comprising” are used in this specification (including the claims) they are to be interpreted as specifying the presence of the stated features, integers, steps or components, but not precluding the presence of one or more other features, integers, steps or components.

A reference herein to a patent document or any other matter identified as prior art, is not to be taken as an admission that the document or other matter was known or that the information it contains was part of the common general knowledge as at the priority date of any of the claims.

### DETAILED DESCRIPTION OF EMBODIMENTS

Neural language models are increasingly being deployed in various critical application domains such as healthcare, legal systems and banking. Pre-trained sentence encoders are trained on massive text corpora to learn sentence-level text representations that are useful for downstream natural language processing tasks. These word and sentence level representations often exhibit societal biases which may arise from stereotypical patterns in the existing training data as well as from creation and amplification of these patterns during the training process.

Pre-trained sentence embeddings are crucial for downstream tasks and achieve superior performance compared to word representation. However, sentence-level debiasing is challenging for at least the following reasons. First, it is computationally expensive to retrain massive scale sentence encoder models. Second, sentence representations learn and encode highly complex associations and contextual inter-dependencies. This makes it difficult to scale word-level debiasing approaches to operate at the sentence-level. A third, challenge arises out of the language model's typical use case as part of a downstream task. In particular, debiasing the sentence embeddings directly is not sufficient because new biases could later be re-introduced in the fine-tuning process of the downstream task. Debiasing the fine-tuning process, however, is fraught with difficulty due to a typical strategy for debiasing often involving a projection onto a less biased subspace. However, these high-capacity networks can simply learn to invert the debiasing projection.

For example, if weights of bias attribute words are simply scaled by multiplicative constants, the model easily learns to undo these scalings. Moreover, a strategy of constraining where transformers self-attention mechanism can attend is also insufficient. The reason is that information escapes from the query and the keys. Additionally, information in the lower layers of a transformer rapidly diffuses into the top layers, and the interpretation of attention as focusing on specific words ceases to be valid. Therefore, a strategy based on limiting the attention mechanism alone is insufficient.

Previous debiasing approaches commonly operate at word embeddings with the few sentence-level debiasing approaches constructing a bias sub-space e.g., by performing PCA on sentence templates collected from extensive text corporyand then subtracting the projections of a sentence representation onto the bias subspace. However, there is an underlying assumption on the linearity of the bias in the sentence embedding space. Additionally, the calculation of bias directions depends highly on the embeddings extracted from the training datand the number of principal components, preventing the method from adequate generalization. Research on neural debiasing of contextual representations also relies on massive independent text corpora to construct augmentation examples. The novel approach presented herein does not assume linearity of bias and does not require complex computation of bias subspaces resulting in a relatively simpler and more efficient algorithm.

In various embodiments, techniques may be performed where injection of bias in a language model generated through fine tuning of a pre-trained language model may be mitigated. A pre-trained language model may be fine-tuned using downstream training data. Prior to tuning, elements within the downstream data may be identified that correlate with one or more identity elements associated with training bias sensitivity. Then, instances of the identified elements may be replaced in the downstream data with masking elements to generate masked downstream data. A fine-tuned language model with reduced bias may then be generated from the pre-trained language model by tuning the pre-trained language model using the masked downstream data.

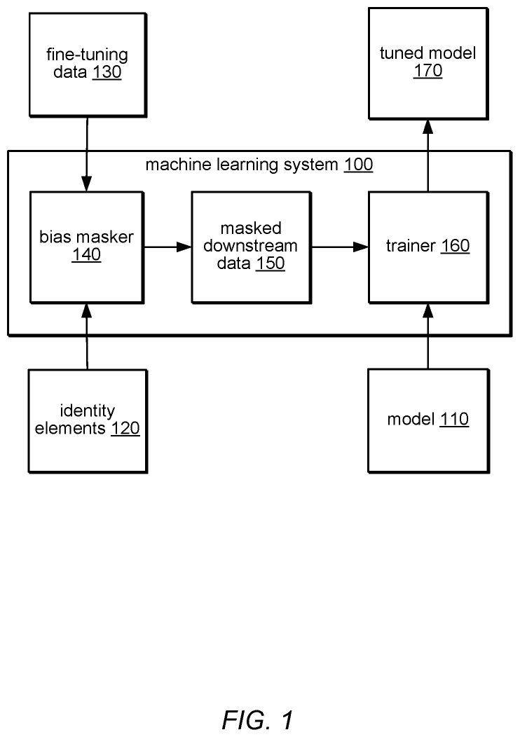

FIG. 1 is a block diagram of a machine learning system that provides fairness when fine-tuning pre-trained language models, according to some embodiments. A machine learning system 100 may include a machine learning model trainer 160 that may be used to train machine learning models, such as language models, or to fine-tune an existing machine learning model 110 using fine-tuning data 130 to generate a tuned model 170.

To provide fairness when fine-tuning an existing machine learning model 110, the machine learning system 100 may generate masked downstream data 150 to use as input to the trainer. This masked downstream data 150 may be generated by a bias masker 140 using the fine-tuning data 130 and a collection, or dictionary, of previously identified identity elements 120. In some embodiments, this collection of identity elements 120 may be used in the training or fine-tuning of multiple language models and may be maintained and updated separate from the tuned models. In this way, updates to the identity element dictionary may be used to further refine tuned models and further decrease bias.

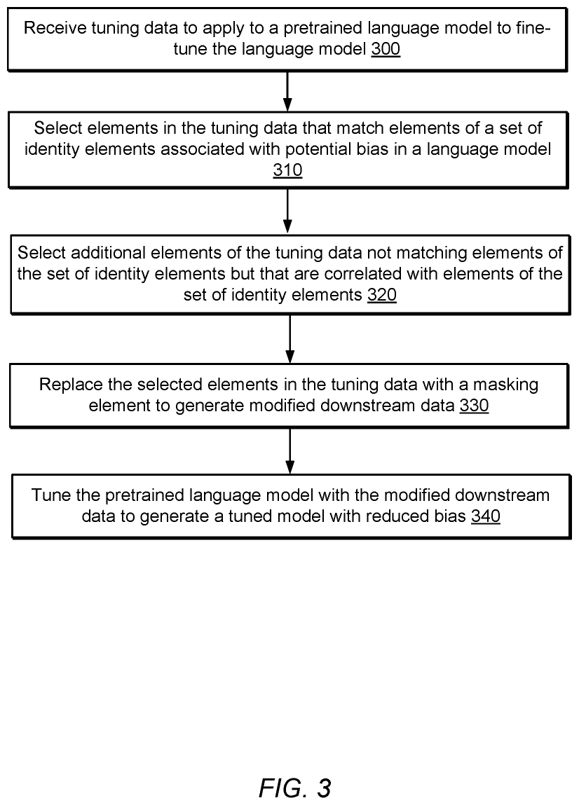

To provide fairness when fine-tuning pretrained language models, two steps may be performed, in various embodiments. First, is to identify elements in the downstream data, that are correlated with the identity elements and second is to implement element dropout at fine-tuning, based on these correlations. FIG. 3 is flow diagram illustrating a process for provides fairness when fine-tuning pre-trained language models, according to some embodiments. In the various embodiments, the term “element” refers to any encoding of unique terms or vocabulary items within a language. For example, an element may be an ASCII representation of particular word or phrase while, in another example, an element may be an enumeration or tokenized representation of a particular word or phrase. Any encoding of individual elements may be used and the included examples are not intended to be limiting.

Downstream data for fine-tuning of language models may be preprocessed to remove information for identity elements and elements correlated with the identity elements (and therefore, serving as proxies). Normalized point-wise mutual information (npmi) may, in some embodiments, server as a measure of correlation (based on co-occurrences) between any pair of elements. For each identity element i∈I, where I is the set of identity elements, we compute the npmi with elements in the vocabulary (of the fine-tuning data). We replace elements that are highly correlated with identity words, with a masking element. This is performed according to a set of word dropout heuristics which will be described below. All identity elements may also be replaced with the masking element. Then the pre-trained language model may be fine-tuned on this masked dataset (in which the identity elements and the proxies have been replaced with masking). This encourages the model to not rely on the identity words and the elements which have stronger associations with the identity words.

Let I denote the set of identity words in downstream data. For example, words associated with gender may be associated with potential bias in a language model, therefore a set of identity words I={male, female, . . . } etc. Identity elements may fall one or more of multiple identity groups, for example gender, age and nationality. A method is described to stochastically drop out elements that are correlated with these identity words. To determine this correlation, a point-wise mutual information (pmi) of each element in the fine-tuning data may be computed with respect to each of the identity elements.

The pmi of a pair of outcomes x and y belonging to discrete random variables X and Y quantifies the discrepancy between the probability of their coincidence given their joint distribution and their individual distributions, assuming independence. Mathematically:

pmi(x;y)=p(x,y)/p(x)p(y)

Pointwise mutual information may be normalized between [−1, +1] resulting in −1 (in the limit) for never occurring together, 0 for independence, and +1 for complete co-occurrence.

npmi(x;y)=pmi(x,y)/h(x;y)

where h(x; y) is the joint self-information estimated as −log p(X=x, Y=y). For each element t encountered in the downstream data, a set of npmi scores npmi(t; i) with each of the identity elements i∈I to generate a correlation score for the element t.

In some embodiments, for each element, the correlation score may be the highest npmi with respect to all the identity words. All elements that have correlation score>θ, where θ is a predetermined threshold, may be masked. In some embodiments, a stochastic variation may be performed wherein elements with probability proportional to the correlation scores may be masked. θ may be computed as a hyper parameter of the fine-tuning optimized using the validation data.

In still other embodiments, element masking may be performed at each sentence. Within each sentence, if there are identity elements present, elements with probability proportional to the npmi with the identity words present may be masked. In some embodiments, elements with highest npmi with the identity words may be masked.

In some cases, identity groups may be coupled. Therefore, a difference in true Positive Rate (TPR) may be computed between the two identity groups, for example gender and occupation. This difference may be denoted as a TPR gap. A higher TPR gap for a given group implies that the model is more likely to classify one of the identity groups much more accurately compared to the other, thereby indicating bias in the downstream predictions. This proposed approach acts directly at the fine-tuning stage thereby addressing downstream bias. This approach generalizes to multiple protected attributes.

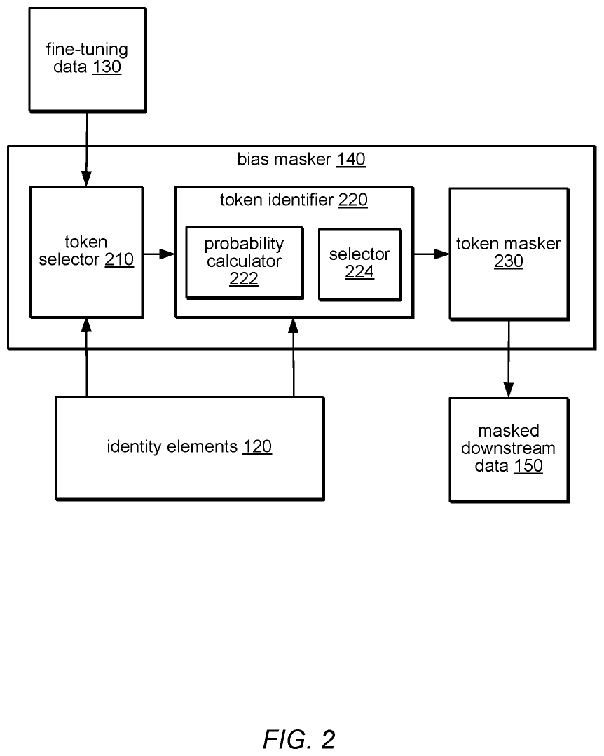

FIG. 2 is a block diagram of a bias masker of a machine learning system that masks identity elements and proxies for identity elements from a data set before training of a language model, according to some embodiments. A bias masker 140 of a machine learning system, such as the machine learning system 100 of FIG. 1, may receive fine-tuning data 130 and select elements, or tokens, of the fine-tuning data, in some embodiments, to be evaluated.

In some embodiments, all elements in the tuning data set may be selected for evaluation. In other embodiments, only a portion of the data set may be selected. For example, elements to be evaluated may be limited to only elements that appear in sentences that also contain one or more identity elements 120, in some embodiments. In still other embodiments, elements to be evaluated may be limited to only elements that appear in sentences that also contain one or more identity elements, and those selected may be evaluated only with respect to the specific identity elements 120 that appear with the same sentence. It should be understood, however, that these limiting techniques are merely examples and other means of restricting or selecting elements for evaluation may be employed, in various embodiments.

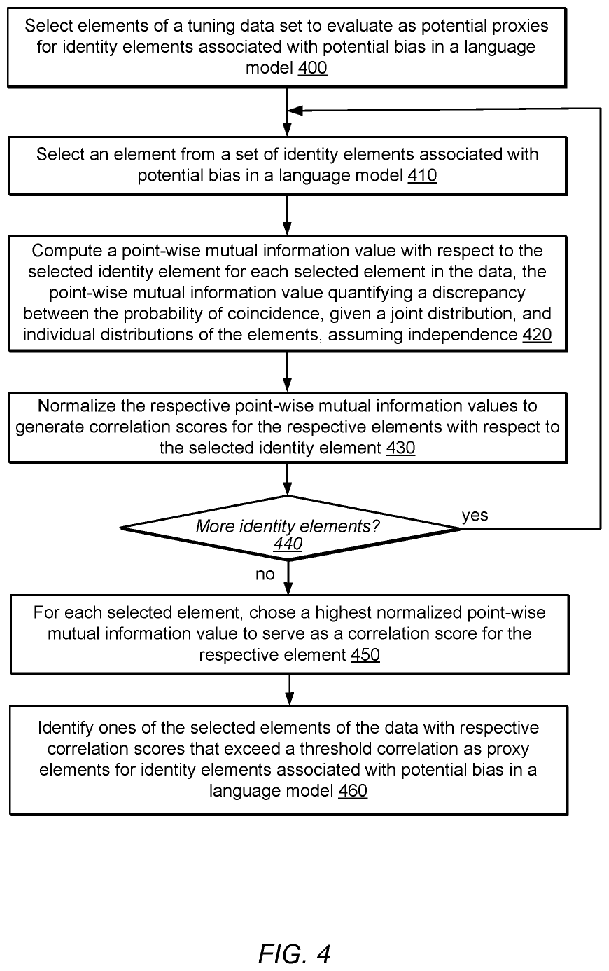

A token identifier 220 may then analyze the selected tokens to identify tokens that may be associated with bias, in some embodiments. This token identifier may select elements in the fine-tuning data 130 matching the identity elements 120, in some embodiments. In addition, the token identifier 220 may also identify elements that may serve as a proxy for, or convey similarly biased information as, elements of the set of identity elements. These additional elements may correlate with elements of the set of identity elements, in some embodiments. Details on the selection of these proxy elements is provided below in FIG. 4.

A probability calculator 222 may be employed, in some embodiments, to identify elements that serve as a proxy for, or convey similarly biased information as, elements of the set of identity elements by calculating respective correlation scores for selected elements. To determine these correlation scores, point-wise mutual information (pmi) of each element in the fine-tuning data set may be computed with respect to each of the identity elements.

The pmi of a pair of outcomes x and y belonging to discrete random variables X and Y quantifies the discrepancy between the probability of their coincidence given their joint distribution and their individual distributions, assuming independence. Mathematically:

pmi(x;y)=p(x,y)/p(x)/p(y)

This pointwise mutual information may be further normalized between [−1, +1] resulting in −1 (in the limit) for never occurring together, 0 for independence, and +1 for complete co-occurrence.

npmi(x;y)=pmi(x,y)/h(x;y)

where h(x; y) is the joint self-information estimated as −log p(X=x, Y=y). For each element t encountered in the downstream data, a set of npmi scores npmi(t; i) with each of the identity elements i∈I to generate a correlation score for the element t.

In some embodiments, for each element, the correlation score may be the highest npmi with respect to all the identity words or all identity words within the same sentence as the element. A selector 224 may select elements for masking that have a sufficient probability of serving as a proxy for at least one identity element, in some embodiments. To accomplish this selection, all elements that have correlation score>θ, where θ is a predetermined threshold, may be selected. In some embodiments, a stochastic variation may be performed wherein elements with probability proportional to the correlation scores may be selected. θ may be further computed as a hyperparameter of the fine-tuning optimized using the validation data.

The selected identity and proxy elements may then be replaced in the fine-tuning data with one or more masking elements in the token masker 230 to generate masked downstream data 150. In some embodiments, a single masking element may be substituted for each of the selected elements, regardless of the identity element(s) that the replaced elements may be correlated with, while in other embodiments different masking elements may be used. Furthermore, in some embodiments, identified elements may merely be removed rather than replaced by as masking element. While the mere existence of a masking element may convey information introducing bias, as the dictionary of identity elements grows to include a sufficient diversity of identity elements, it should be understood that the amount of potentially biasing information conveyed by masking elements lessens, therefore the use of one or more masking elements rather than simple deletions of identity and proxy elements may introduce little biasing information while simultaneously mitigating pre-existing bias in a pre-trained language model subject to fine-tuning. It should be further understood, that these deletions and substitutions of identified elements are merely examples and any number of techniques to remove or mask potentially biasing elements may be employed, in various embodiments.

The masked downstream data 150 may then be used to train machine learning models, such as language models, or to fine-tune an existing machine learning model to generate a tuned model, such as the tuned model 170 as shown in FIG. 1, in some embodiments.

FIG. 3 is flow diagram illustrating a process for provides fairness when fine-tuning pre-trained language models, according to some embodiments. As shown in step 300, a machine learning system, such as the machine learning system 100 as shown in FIG. 1, may receive tuning data, such as the fine-tuning data 130 as shown in FIG. 1, to apply to a pretrained language model, such as the model 110 of FIG. 1, in some embodiments, to generate a fine-tuned model such as the tuned model 170 of FIG. 1.

Then, as shown in 310, elements of the received tuning data may be selected which match various ones of a set of identity elements, such as the identity elements 120 of FIG. 1, that are associated with potential bias in a language model, in some embodiments. This set, or dictionary, of identity elements may be used in the training or fine-tuning of multiple language models and may be maintained and updated separate from the tuned models, in some embodiments. In this way, updates to the identity element dictionary may be used to further refine tuned models to further decrease bias.

As shown in 320, additional elements of the tuning data that, while not matching elements of the set of identity elements, may serve as a proxy for, or convey similarly biased information as, elements of the set of identity elements may be selected. These additional elements may correlate with elements of the set of identity elements, in some embodiments. Details on the selection of these proxy elements is provided below in FIG. 4.

As shown in 330, these selected identity and proxy elements may then be replaced in the fine-tuning data with one or more masking elements to generate masked downstream data. In some embodiments, a single masking element may be substituted for each of the selected elements, regardless of the identity element(s) that the replaced elements may be correlated with, while in other embodiments different masking elements may be used. Furthermore, in some embodiments, identified elements may merely be removed rather than replaced by as masking element. While the mere existence of a masking element may convey information introducing bias, as the dictionary of identity elements grows to include a sufficient diversity of identity elements, it should be understood that the amount of potentially biasing information conveyed by masking elements lessens, therefore the use of one or more masking elements rather than simple deletions of identity and proxy elements may introduce little biasing information while simultaneously mitigating pre-existing bias in a pre-trained language model subject to fine-tuning. It should be further understood, that these deletions and substitutions of identified elements are merely examples and any number of techniques to remove or mask potentially biasing elements may be employed, in various embodiments.

Finally, as shown in 340, the masked tuning data may be used to fine-tune a pretrained language model to generate a tuned model, such as the tuned model 170 of FIG. 1, with reduced bias.

FIG. 4 is flow diagram illustrating a process for masking proxies for identity elements from a training data set, according to some embodiments. As shown in 400, elements of a tuning data set, such as the fine-tuning data 130 as shown in FIG. 1 and FIG. 2, may be selected to evaluate, such as by the token selector 210 of FIG. 2, to determine elements that may serve as proxies for identity elements, such as the identity elements 120 of FIG. 1 and FIG. 2, that may be associated with potential bias in a language model.

In some embodiments, all elements in the tuning data set may be selected while in other embodiments only a portion of the data set may be selected. For example, elements to be evaluated may be limited, in some embodiments, to only elements that appear in sentences that also contain one or more identity elements. It should be understood, however, that this limitation is merely an example and other means of restricting or selecting elements for evaluation may be employed, in various embodiments.

As shown in 410, an element of a set of identity elements, such as the identity elements 120 of FIG. 1, may be selected, where the identity elements are elements within the language that may be associated with a potential for bias in a language model, in various embodiments.

For the selected identity element, a point-wise mutual information value may be computed for each element in the fine-tuning downstream data set, as shown in 420, in some embodiments. This computed point-wise mutual information value may quantify a discrepancy between the probability of coincidence given a joint distribution and individual distributions of the elements and may be expressed as a ratio of the probability of joint distribution with respect to respective probabilities of individual distribution of the element and the selected identity element, in some embodiments. Elements with high relative ratios may in some embodiments be more likely to serve as proxies for the selected identity element than elements with low relative ratios.

Then, as shown in 430 the respective point-wise mutual information values for the downstream data elements may be normalized to a standardized range, in some embodiments. Should additional identity elements exist, as shown in a positive exit from 440, the process may return to 410. Should no additional identity elements exist, as shown in a negative exit from 440, the process may continue to step 450.

As shown in 450, for each selected element to evaluate, a highest normalized score for the element may be chosen to generate a respective correlation score for that element, in some embodiment. Then, as shown in 460, selected elements of the downstream tuning data with respective correlation scores that exceed a threshold correlation may be identified for masking, in some embodiments.

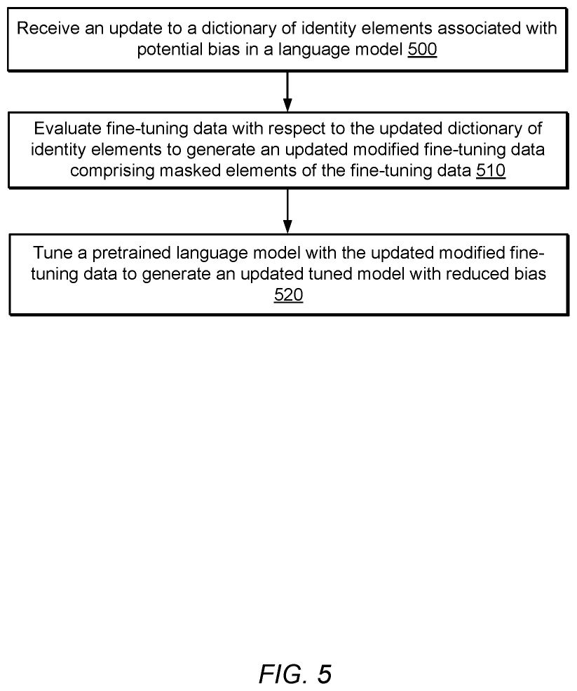

FIG. 5 is flow diagram illustrating a process for updating a language model according to an updated set of identity elements. according to some embodiments. As shown in 500, the process begins by receiving an update to a dictionary of identity elements, such as the identity elements 120 of FIG. 1, associated with potential bias in a language model, in some embodiments.

As shown in 510, fine-tuning data, such as the fine-tuning data 130 of FIG. 1, may then be evaluated with respect to this updated dictionary to generate an updated fine-tuning data set that includes masked elements, where the masked elements include instances of identity elements and additional elements that may serve as a proxy for, or convey similarly biased information as, elements of the set of identity elements. These additional elements may correlate with elements of the set of identity elements, in some embodiments. This evaluation is further discussed on FIGS. 1-4 above.

Finally, as shown in 520, the updated masked tuning data may be used to fine-tune a pretrained language model to generate a updated tuned model, such as the tuned model 170 of FIG. 1, with reduced bias.

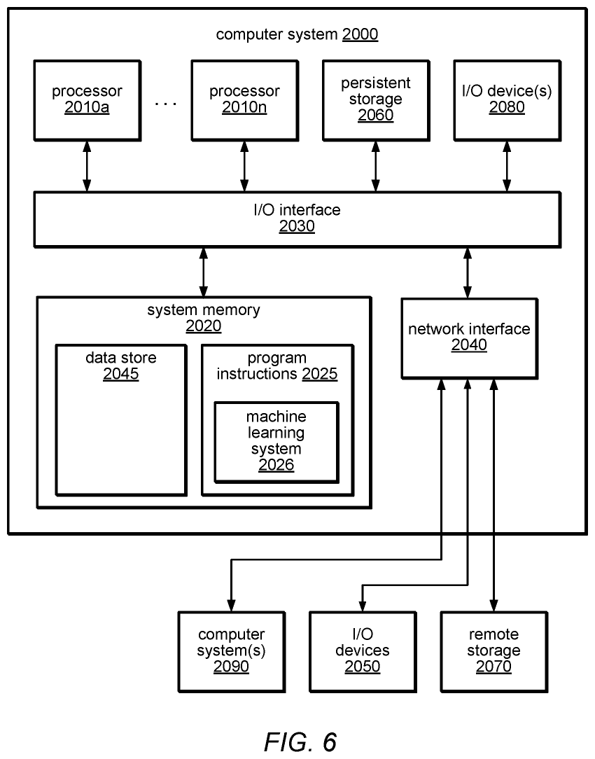

Any of various computer systems may be configured to implement processes associated with a machine learning system as discussed with regard to the various figures above. FIG. 6 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 6 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 may include one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions.

For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above providing a machine learning system as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.11, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of machine learning system as described herein may be executed on one or more computer systems, which may interact with various other devices. FIG. 6 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

Program instructions 2025 may be encoded in a platform native binary, any interpreted language such as Java™ byte-code, or in any other language such as C/C++, the Java™ programming language, etc., or in any combination thereof, to implement various applications such as a machine learning system 2026. In various embodiments, applications, operating systems, and/or shared libraries may each be implemented in any of various programming languages or methods. For example, in one embodiment, operating system may be based on the Java™ programming language, while in other embodiments it may be written using the C or C++ programming languages. Similarly, applications may be written using the Java™ programming language, C, C++, or another programming language, according to various embodiments. Moreover, in some embodiments, applications, operating system, and/shared libraries may not be implemented using the same programming language. For example, applications may be C++ based, while shared libraries may be developed using C.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A method, comprising:
receiving tuning data to tune a pre-trained language model;
identifying one or more proxy elements of a plurality of elements in the tuning data that correlate with one or more identity elements associated with training bias, the identifying comprising:
computing respective correlation scores for at least a portion of elements of the plurality of elements; and
selecting particular elements of the at least a portion of elements with respective correlation scores that exceed a correlation threshold as proxy elements;
replacing the identified one or more proxy elements and one or more identity elements in the tuning data with masking elements to generate masked tuning data; and
tuning the pre-trained language model with the masked tuning data to generate a tuned language model with reduced bias.

2. The method of claim 1, wherein the correlation threshold is determined according to a probability proportional to a bias score.

3. The method of claim 1, wherein the correlation threshold of a particular element of the plurality of elements is determined according to a probability proportional to a correlation score of the particular element.

4. The method of claim 1, wherein the at least a portion of elements of the plurality of elements for which respective correlation scores are computed comprises individual tokens of the tuning data.

5. The method of claim 1, wherein the at least a portion of elements of the plurality of elements for which respective correlation scores are computed comprises individual tokens of the tuning data within sentences also including identity elements.

6. The method of claim 1, wherein computing a correlation score for particular element of the individual elements comprises:
computing, for individual elements of the one or more identity elements associated with training bias, respective ratios of respective probabilities of joint distribution with respect to respective probabilities of individual distribution; and
assigning a highest ratio of the respective ratios as the correlation score.

7. The method of claim 1, further comprising:
receiving a dictionary defining the one or more identity elements associated with training bias prior to identifying one or more proxy elements of a plurality of elements in the tuning data that correlate with one or more identity elements associated with training bias;
receiving, subsequent to generating the tuned language model, a updated dictionary with a one or more different identity elements associated with training bias, and responsive to receiving the updated dictionary:
generating updated masked tuning data; and
generating an updated tuned language model with reduced bias using the updated masked tuning data.

8. One or more non-transitory, computer-readable storage media storing program instructions that, when executed on or across one or more computing devices, cause the one or more computing devices to implement:
receiving tuning data to tune a pre-trained language model;
identifying one or more proxy elements of a plurality of elements in the tuning data that correlate with one or more identity elements associated with training bias, wherein in identifying the one or more proxy elements, the program instructions cause the one or more computing devices to implement:
computing respective correlation scores for at least a portion of elements of the plurality of elements; and
selecting particular elements of the at least a portion of elements with respective correlation scores that exceed a correlation threshold as proxy elements;
replacing the identified one or more proxy elements and one or more identity elements in the tuning data with masking elements to generate masked tuning data; and
tuning the pre-trained language model with the masked tuning data to generate a tuned language model with reduced bias.

9. The one or more non-transitory computer-accessible storage media of claim 8, wherein the correlation threshold is determined according to a probability proportional to a bias score.

10. The one or more non-transitory computer-accessible storage media of claim 8, wherein the correlation threshold of a particular element of the plurality of elements is determined according to a probability proportional to a correlation score of the particular element.

11. The one or more non-transitory computer-accessible storage media of claim 8, wherein the at least a portion of elements of the plurality of elements for which respective correlation scores are computed comprises individual tokens of the tuning data.

12. The one or more non-transitory computer-accessible storage media of claim 8, wherein the at least a portion of elements of the plurality of elements for which respective correlation scores are computed comprises individual tokens of the tuning data within sentences also including identity elements.

13. The one or more non-transitory computer-accessible storage media of claim 8, wherein computing a correlation score for particular element of the individual elements comprises:
computing, for individual elements of the one or more identity elements associated with training bias, respective ratios of respective probabilities of joint distribution with respect to respective probabilities of individual distribution; and
assigning a highest ratio of the respective ratios as the correlation score.

14. The one or more non-transitory computer-accessible storage media of claim 8, further comprising:
receiving a dictionary defining the one or more identity elements associated with training bias prior to identifying one or more proxy elements of a plurality of elements in the tuning data that correlate with one or more identity elements associated with training bias;
receiving, subsequent to generating the tuned language model, a updated dictionary with a one or more different identity elements associated with training bias, and responsive to receiving the updated dictionary:
generating updated masked tuning data; and
generating an updated tuned language model with reduced bias using the updated masked tuning data.

15. A system, comprising:
at least one processor; and
a memory storing program instructions that, when executed by the at least one processor, cause the at least one processor to implement a machine learning system configured to:
receive tuning data to tune a pre-trained language model;
identify one or more proxy elements of a plurality of elements in the tuning data that correlate with one or more identity elements associated with training bias, wherein to identify the one or more proxy elements, the program instructions cause the at least one processor to:
compute respective correlation scores for at least a portion of elements of the plurality of elements; and
select particular elements of the at least a portion of elements with respective correlation scores that exceed a correlation threshold as proxy elements;
replace the identified one or more proxy elements and one or more identity elements in the tuning data with masking elements to generate masked tuning data; and
tune the pre-trained language model with the masked tuning data to generate a tuned language model with reduced bias.

16. The system of claim 15, wherein the correlation threshold is determined according to a probability proportional to a bias score.

17. The system of claim 15, wherein the correlation threshold of a particular element of the plurality of elements is determined according to a probability proportional to a correlation score of the particular element.

18. The system of claim 15, wherein the at least a portion of elements of the plurality of elements for which respective correlation scores are computed comprises individual tokens of the tuning data.

19. The system of claim 15, wherein the at least a portion of elements of the plurality of elements for which respective correlation scores are computed comprises individual tokens of the tuning data within sentences also including identity elements.

20. The system of claim 15, wherein to compute a correlation score for particular element of the individual elements, the machine learning system is configured to:
compute, for individual elements of the one or more identity elements associated with training bias, respective ratios of respective probabilities of joint distribution with respect to respective probabilities of individual distribution; and
assign a highest ratio of the respective ratios as the correlation score.
